(19) United States
(12) Patent Application Publication
(10) Pub. No.: US 2011/0078657 A1
(43) Pub. Date: Mar. 31, 2011

(54) OPERATION MANAGEMENT SERVER, ROLLBACK EXECUTION METHOD, AND ROLLBACK EXECUTION PROGRAM

(76) Inventor: Yoshihiro Okada, Tokyo (JP)

(21) Appl. No.: 12/882,676

(22) Filed: Sep. 15, 2010

(30) Foreign Application Priority Data
Sep. 25, 2009 (JP) JP2009-220347

(51) Int. Cl. G06F 9/44

(52) U.S. Cl. 717/116

(57) ABSTRACT

When a failure occurred, the state of a system is returned to a state before the failure. An operation management server for managing operation of an application using Java® includes: an update processing execution unit which, when a method which involves update of data is called up, obtains pre-update data which is a target of the update and executes update processing corresponding to the method; a first abnormal end determination unit which determines whether the update processing has ended abnormally; a first rollback unit, which, when the update processing has ended abnormally, returns the update processing target data to the pre-update data; an operation processing execution unit which, when a method which does not involve update of data is called up, executes operation processing corresponding to this method, a second abnormal end determination unit which determines whether the operation processing has ended abnormally; and a second rollback unit, which, when the operation processing has ended abnormally, returns the state to the state before execution of the operation processing.

This application is based upon and claims the benefit of priority from Japanese patent application No. 2009-220347, filed on Sep. 25, 2009, the disclosure of which is incorporated herein in its entirety by reference.

### BACKGROUND

The present invention relates to an operation management server, a rollback execution method and a rollback execution program.

When a failure occurred in a system, rollback is generally executed to return the state of the system back to a state before the occurrence of the failure. Japanese Patent Application Laid-open No. 2006-018540 discloses a technology to execute rollback when a failure is occurred in the middle of update processing for a data base, so as to return the state of the data base back to the start point of the update processing.

Java®, which is an object oriented programming language, has been frequently used for developing a system since the system can be constructed without depending on the platform. To construct a system using Java®, Java® Management Extensions (hereafter called “JMX®”) is normally used as a framework. However, JMX® does not include a structure for, in case of a failure occurrence in the middle of processing, returning the state of the system to the state before the failure. Therefore the client side who will use JMX® must integrate processing for rollback, and this increases the burden for developers.

### SUMMARY

An exemplary object of the invention is to provide an operation management server, a rollback execution method and a rollback execution program that, in case of a failure occurrence, can return the state of the system to the state before the failure without the need at the client side to integrate processing for rollback.

An operation management server according to an exemplary aspect of the present invention is an operation management server for managing operation of an application using an object oriented programming language, including: update processing execution unit for, upon receiving a request to call up a first method which involves an update of data, calling up a method for obtaining pre-update data which is a target of the update, obtaining the pre-update data, and then calling up the first method to execute update processing corresponding to the first method; first abnormal end determination unit for determining whether the update processing has ended abnormally; first rollback unit for, when the first abnormal end determination unit determines that the update processing has ended abnormally, calling up a method for returning the update processing target data to the pre-update data; operation processing execution unit for, upon receiving a request to call up a second method which does not involve update of data, calling up the second method to execute operation processing corresponding to the second method; second abnormal end determination unit for determining whether the operation processing has ended abnormally; and second rollback unit for, when the second abnormal end determination unit determines that the operation processing has ended abnormally, calling up a method for returning the state to the state before execution of the operation processing.

A rollback execution method according to an exemplary aspect of the present invention is a rollback execution method which is executed by a server for managing operation of an application using an object oriented programming language, including: an update processing execution step of calling up, upon receiving a request to call up a first method which involves update of data, a method for obtaining pre-update data which is a target of the update, obtaining the pre-update data, and then calling up the first method to execute update processing corresponding to the first method; a first abnormal end determination step of determining whether the update processing has ended abnormally; a first rollback step of calling up, when it is determined that the update processing has ended abnormally, a method for returning the update processing target data to the pre-update data; an operation processing execution step of calling up, upon receiving a request to call up a second method which does not involve update of data, the second method to execute operation processing corresponding to the second method; a second abnormal end determination step of determining whether the operation processing has ended abnormally; and a second rollback step of calling up, when it is determined that the operation processing has ended abnormally, a method for returning the state to the state before execution of the operation processing is executed.

A computer executes the rollback execution program according to an exemplary aspect of the present invention, executing each step included in the above mentioned rollback execution method.

### DESCRIPTION OF THE DRAWINGS

FIG. 1 is a block diagram depicting a functional configuration of an operation management server according to the present embodiment;

FIG. 2 is a flow chart depicting a processing procedure upon updating an attribute value of an object;

FIG. 3 is a diagram depicting an example of processing content upon updating an attribute value of an object;

FIG. 4 is a flow chart depicting a processing procedure upon executing object operation processing for an object; and

FIG. 5 is a diagram depicting an example of processing content upon executing object operation processing for an object.

### EXAMPLARY EMBODIMENT

Embodiments of the operation management server, rollback execution method and rollback execution program according to the present invention will now be described with reference to the accompanying drawings.

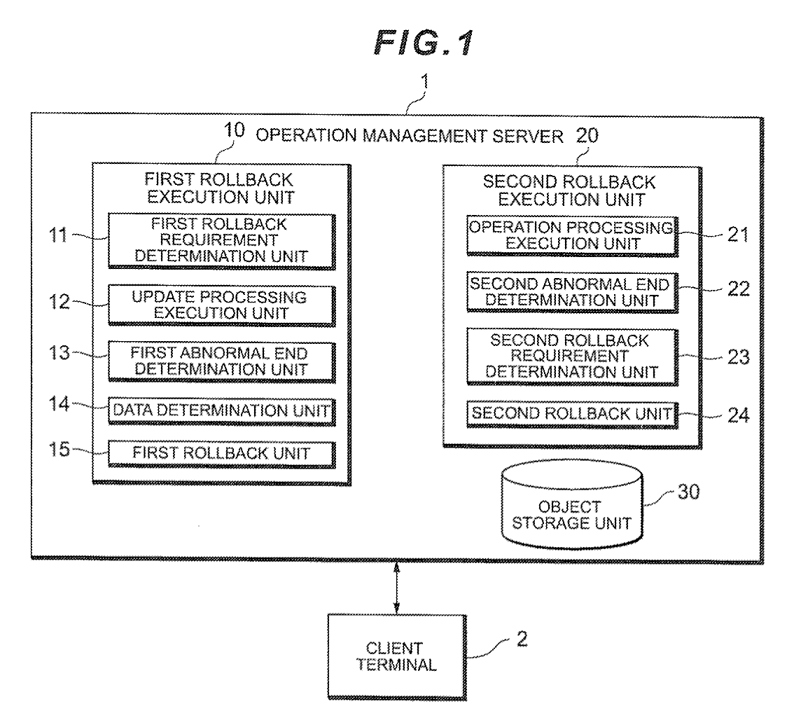

First the configuration of the operation management server will be described with reference to FIG. 1. The operation management server is a server for managing the operation of an object generated by Java® which is an object oriented programming language. In the operation management server, JMX® is installed, and MBean (Managed Bean) which is an object for managing and monitoring applications, and MBeanInfo which is an object for managing information on attributes and the operation of MBean, have been registered. In MBeanInfo, a descriptor area for storing supplementary information, such as comments, for information on attributes and operation of objects, have been created. In the present embodiment, a case of an operation management server, in which JMX® is installed, is described, but the present invention can also be applied to an operation management server in which JMX® is not installed.

A functional configuration of the operation management server according to the present embodiment will be described with reference to FIG. 1. The operation management server 1 has a first rollback execution unit 10 and a second rollback execution unit 20. In the operation management server 1, an object storage unit 30 for storing various objects, including MBean and MBeanInfo, is disposed.

The first rollback execution unit 10 has a first rollback requirement determination unit 11, update processing execution unit 12, first abnormal end determination unit 13, data determination unit 14, and first rollback unit 15. The second rollback execution unit 20 has an operation processing execution unit 21, second abnormal end determination unit 22, second rollback requirement determination unit 23, and second rollback unit 24.

If a request to call up a setter method for updating an attribute value (data) of an object is received from a client terminal 2, the first rollback requirement determination unit 11 determines whether the update processing corresponding to the setter method is processing that requires rollback. Whether the processing requires rollback or not can be determined based on the rollback requirement information which indicates whether the processing requires rollback or not. The rollback requirement information can be stored in the descriptor area created in MBeanInfo, which is an object to define the setter method. As a rollback requirement information which the first rollback requirement determination unit 11 refers to, a name to identify the rollback requirement information is set to “rollback”, for example, and one of “true” or “false” is stored for the value thereof. This value can be stored using a true/false flag, for example. If JMX® is used as the framework, it is preferable to publically specify the setter method.

In concrete terms, if a request to call up the setter method is received, the first rollback requirement determination unit 11 obtains a value of the identification name “rollback” from the descriptor area created in MBeanInfo, which is an object corresponding to the setter method. If the value of the identification name “rollback” is “true”, the first rollback requirement determination unit 11 determines that the update processing corresponding to the setter method requires rollback. If the value of the identification name “rollback” is “false”, on the other hand, the first rollback requirement determination unit 11 determines that the update processing corresponding to the setter method does not require rollback.

The execution of rollback requirement determination is not limited to the case when the setter method is called up. The rollback requirement can be determined when a method (first method), which involves update of data, is called up.

If the first rollback requirement determination unit 11 determines that the update processing corresponding to the setter method requires rollback, the update processing execution unit 12 calls up the getter method for obtaining the attribute value of the update processing target object. By calling up the getter method, pre-update data, which is set in the update processing target attribute, can be obtained. The update processing execution unit 12 temporarily stores the obtained pre-update data in memory. If JMX® is used as a framework, it is preferable to publically specify the getter method.

After the pre-update data is obtained, the update processing execution unit 12 calls up a setter method, which was called up and requested by the client terminal 2. By calling up the setter method, the update processing can be executed.

The first abnormal end determination unit 13 determines whether the update processing executed by the update processing execution unit 12 ended abnormally or not.

If the first abnormal end determination unit 13 determined that the update processing ended abnormally, the data determination unit 14 calls up a getter method for obtaining the attribute value of the update processing target object. By calling up the getter method, the update processing target update data can be obtained.

The data determination unit 14 determines whether the obtained update data is different from the pre-update data, which the update processing execution unit 12 stored in memory.

If the data determination unit 14 determined that the update data is different from the pre-update data, the first rollback unit 15 sets the pre-update data to an argument of the setter method, and calls up the setter method. By calling up the setter method, the update processing target data can be returned to the pre-update data. In other words, rollback can be performed.

If a request to call up a start method is received from the client terminal 2, for example, as a method for executing an operation of the object, the operation processing execution unit 21 executes the operation processing corresponding to the start method. Execution of the operation processing is not limited to the case when the start method is called up. The operation processing can be executed when a method (second method) which does not involve an update of data (e.g. update of an attribute), such as uploading a file or loading a module, is called up. A method that contains processing to update an attribute during the operation processing may be included in the above mentioned method that involves an update of data.

When a start method is called up by the client terminal 2, for example, the second abnormal end determination unit 22 determines whether the operation processing corresponding to this start method ended abnormally.

If the second abnormal end determination unit 22 determines that the operation processing ended abnormally, the second rollback requirement determination unit 23 determines whether this operation processing requires rollback or not, based on the rollback requirement information. The rollback requirement information can be stored in the descriptor area created in MBeanInfo of an object for defining the start method, for example. For the rollback requirement information which the second rollback requirement determination unit 23 refers to, a method for setting the identification name of the rollback requirement information to “rollbackMethod” and deleting the operation processing as the value thereof, that is, a method for returning the state of the system to the state before executing the operation processing, can be stored. As a method for returning the state to the state before executing the operation processing, a stop method that can return the state before executing the start operation can be used if a method for operation processing to be executed is the start method. If a method for operation processing to be executed is a file upload method, then a file delete method that can return the state to the state before executing the file upload operation can be used.

In concrete terms, if the operation processing ended abnormally, the second rollback requirement determination unit 23 obtains a value of the identification name “rollbackMethod” from the descriptor area created in MBeanInfo, which is an object corresponding to the start method. If the value of the identification name “rollbackMethod” can be obtained, the second rollback requirement determination unit 23 determines that the operation processing corresponding to the start method requires rollback. If the value of the identification name “rollbackMethod” cannot be obtained, the second rollback requirement determination unit 23 determines that the operation processing corresponding to the start method does not require rollback.

If the second rollback requirement determination unit 23 determines that the operation processing requires rollback, the second rollback unit 24 calls up a method that is stored as a value of the identification name “rollbackMethod”.

The above mentioned function of each section of the first rollback execution unit 10 and the second rollback execution unit 20 can be implemented by executing a shared method of a shared object, which is stored in the object storage unit 30. The shared method is executed when a method for each object (excluding a shared object) stored in the object storage unit 30 is called up.

By implementing the function of each section of the first rollback execution unit 10 and the second rollback execution unit 20 by executing a shared method of a shared object, problems of independently integrating the rollback processing into each object (MBean), so as to return the state to the state before failure, can be avoided. Thereby operation burdens on the developer can be decreased. If rollback processing is independently integrated into each object, then it is possible that the developer would forget to integrate a part of the processing, and in such a case, data consistency may be lost when a failure occurs. In the case of the present invention, on the other hand, the operation to integrate the rollback processing can be omitted by registering a shared object that defines a shared method. As a consequence, data consistency, when a failure occurs, can be guaranteed.

Here the operation management server 1 physically includes a CPU, a memory and an input/output interface, for example. The memory includes a ROM and HDD, which store programs and data processed by the CPU, and a RAM, which is primarily used as an area for various operations for control processing. These components are inter-connected via a bus. The function of each section in the above mentioned operation management server 1 can be implemented by the CPU, which executes the programs stored in ROM, and processes various messages received via the input/output interface and various data developed in RAM.

Operation of the operation management server according to the present embodiment will now be described with reference to the drawings.

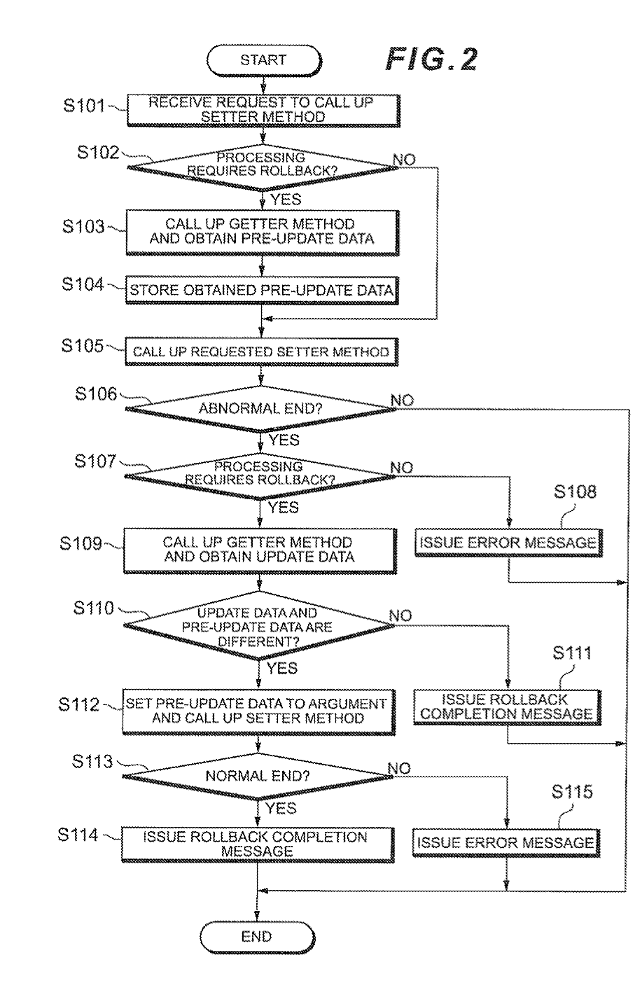

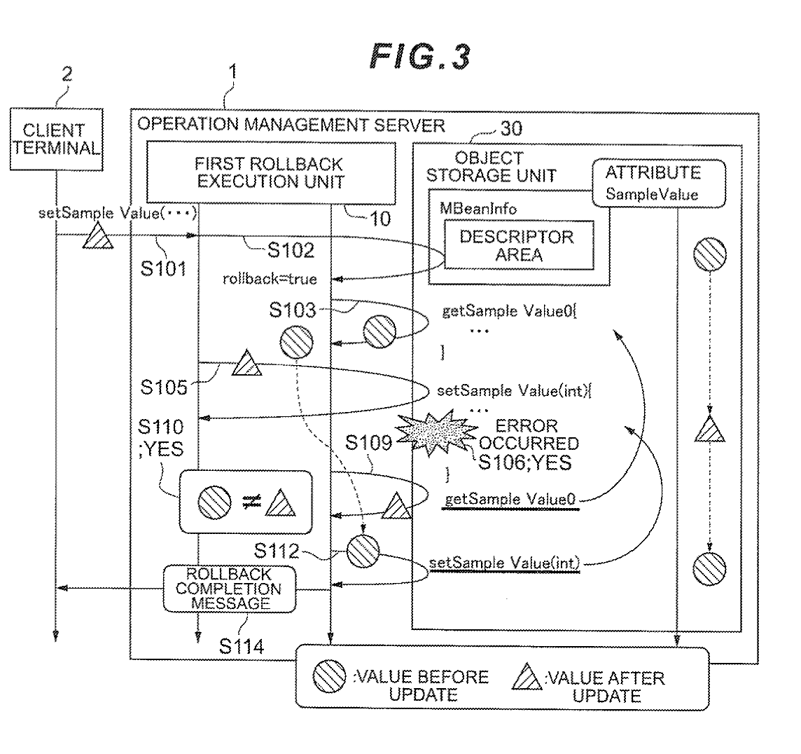

The operation upon updating an attribute value of an object will be described first with reference to FIG. 2 and FIG. 3. FIG. 2 is a flow chart depicting a processing procedure upon updating an attribute value of an object. FIG. 3 shows a diagram depicting an example of processing content (example of successful rollback) upon updating an attribute value of an object.

When a request to call up a setter method for updating an attribute value of an object is received from a client terminal 2 (step S101), the first rollback requirement determination unit 11 of the operation management server 1 refers to MBeanInfo, and determines whether the update processing corresponding to the setter method is processing that requires rollback (step S102). If this determination is NO (step S102: NO), processing advances to the later mentioned step S105.

If it is determined that the update processing corresponding to the setter method is processing that requires rollback in the determination in step S102 (step S102: YES), the update processing execution unit 12 calls up a getter method for obtaining an attribute value of an object to be a target of the update processing, and obtains pre-update data (step S103). The update processing execution unit 12 stores the obtained pre-update data in memory (step S104).

Then the update processing execution unit 12 calls up the setter method requested in step S101, and executes the update processing corresponding to the setter method (step S105).

Then the first abnormal end determination unit 13 determines whether update processing executed by the update processing execution unit 12 ended abnormally (step S106). If this determination is NO (step S106: NO), this processing procedure ends.

If it is determined that the update processing ended abnormally in the determination in step S106 (step S106: YES), and the update processing requires rollback (step S107: YES), the data determination unit 14 calls up a getter method for obtaining the attribute value of the update processing target object, and obtains the update processing target update data (step S109).

Then the data determination unit 14 determines whether the update data obtained in step S109 is different from the pre-update data stored in step S104 (step S110). If this determination is NO (step S110: NO), a rollback completion message, to indicate the normal completion of rollback, is issued (step S111), and this processing procedure ends. This rollback completion message includes a message to indicate that update processing corresponding to the setter method requested by the client terminal 2 was not executed.

If it is determined that the update data is different from the pre-update data in the determination in step S110 (step S110: YES), on the other hand, the first rollback unit 15 sets the pre-update data to the argument of the setter method, and calls up this setter method (step S112). Thereby the update processing target data can be returned to the pre-update data state.

If the setter method called up in step S112 ended normally (step S113: YES), the rollback completion message is issued (step S114), and this processing procedure ends. If the setter method called up in step S112 ended abnormally (step S113: NO), on the other hand, an error message to indicate that the update processing corresponding to the setter method requested by the client terminal 2 ended abnormally is issued (step S115), and this procedure ends. Instead of this error message, a message to indicate failure of rollback may be issued.

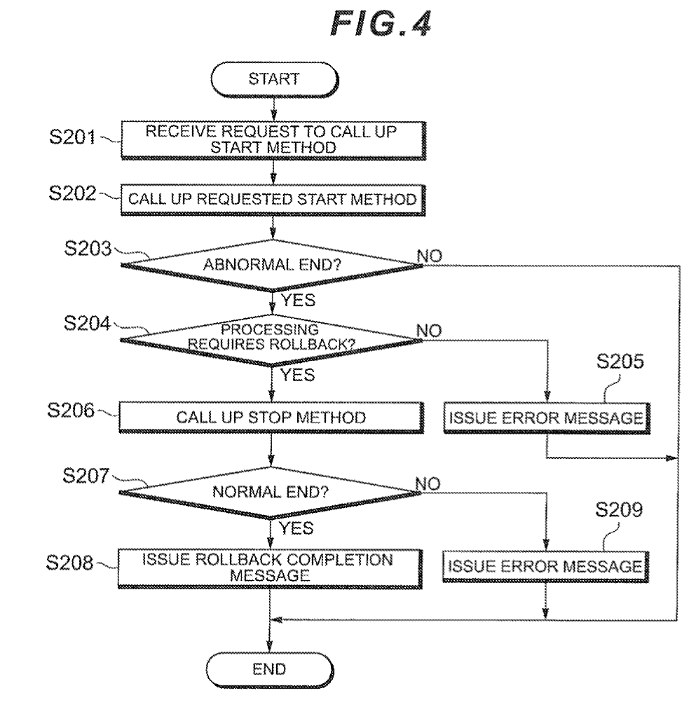

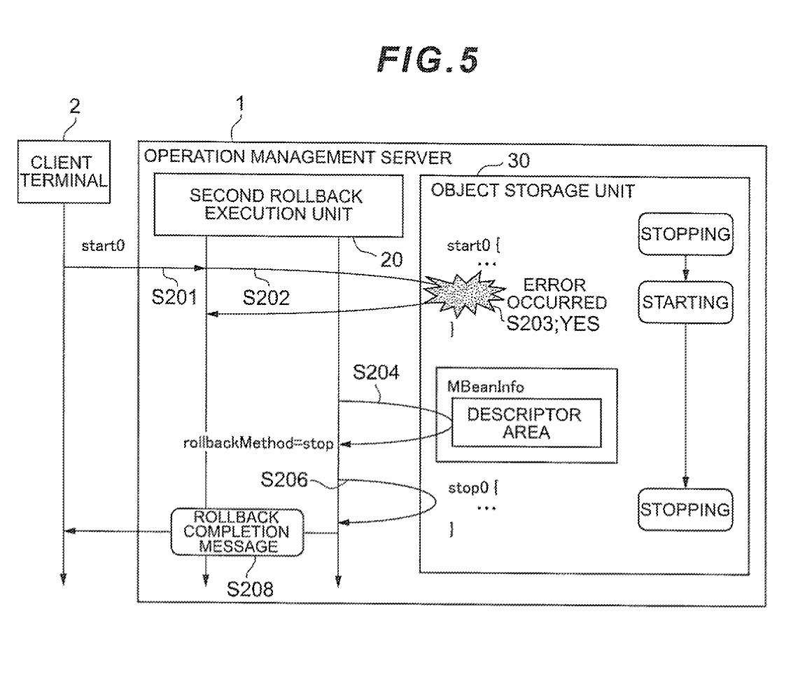

Now operation upon executing an operation processing for an object will be described with reference to FIG. 4 and FIG. 5. FIG. 4 is a flow chart depicting a processing procedure upon executing an operation processing for an object. FIG. 5 shows a diagram depicting an example of processing content (example of successful rollback) upon executing an operation processing for an object.

When a request to call up a start method is received from a client terminal 2 as a method for executing operation for an object, for example (step S201), the operation processing execution unit 21 of the operation management server 1 calls up the start method, and executes the operation processing corresponding to the start method (step S202).

The second abnormality end determination unit 22 determines whether the operation processing corresponding to the start method ended abnormally (step S203). If this determination is NO (step S203: NO), this processing procedure ends.

If it is determined that the operation processing corresponding to the start method ended abnormally in the determination in step S203 (step S203: YES), on the other hand, the second rollback requirement determination unit 23 refers to MBeanInfo, and determines whether the operation processing corresponding to the start method is processing that requires rollback (step S204). If this determination is NO (step S204: NO), an error message to indicate that the operation processing corresponding to the start method requested by the client terminal 2 ended abnormally is issued (step S205), and this processing procedure ends.

If it is determined that the operation processing requires rollback in the determination in step S204 (step S204: YES), on the other hand, the second rollback unit 24 refers to MBeanInfo, and calls up a stop method (step S206). When this stop method ends normally, the state can be returned to the state before the operation processing corresponding to the start method was executed.

If the stop method called up in step S206 ended normally (step S207: YES), a rollback completion message to indicate normal completion of rollback is issued (step S208), and this processing procedure ends. If the stop method called up in step S206 ended abnormally (step S207: NO), on the other hand, an error message to indicate that operation processing corresponding to the start method requested by the client terminal 2 ended abnormally is issued (step S209), and this processing procedure ends. Instead of this error message, a message to indicate failure of rollback may be issued.

As mentioned above, according to the operation management server 1 of the present embodiment, if a method that involves an update of data is called up and this update processing ended abnormally, a method for returning the update processing target data to the pre-update data can be called up, and a method that does not involve update processing of the data is called up, and if this operation processing ended abnormally, a method for returning the state of the system to the state before execution of the operation processing can be called up. Since this allows to perform rollback upon occurrence of a failure, the state of the system can be returned to the state before failure, even if a failure occurs.

By registering a shared object that defines a shared method for performing the rollback processing, it becomes unnecessary to integrate rollback processing for each object upon the occurrence of a failure, so an operation burden on the developers can be decreased, and data consistency upon occurrence of a failure can be guaranteed.

The above embodiment is merely an example, and does not exclude various modifications and the use of technology, which are not explicitly stated in the embodiment. In other words, the present embodiment can be modified in numerous ways without departing from the spirit and scope of the invention.

Each composing element of the operation management server 1 described in the above embodiment is shown in FIG. 1, but the operation management server 1 does not always have all of these composing elements. For example, the operation management server 1 can have at least the update processing execution unit 12, first abnormal end determination unit 13, first rollback unit 15, operation processing execution unit 21, second abnormal end determination unit 22, and second rollback unit 24.

An exemplary advantage according to the present invention is, a state of a system when a failure occurred can be returned to a state before failure without the need for the client side to integrate processing for rollback.

The whole or part of the exemplary embodiments disclosed above can be described as, but not limited to, the following supplementary notes.

(Supplementary note 1) An operation management server for managing operation of an application using an object oriented programming language, including:

update processing execution unit for, upon receiving a request to call up a first method which involves an update of data, calling up a method for obtaining pre-update data which is a target of the update, obtaining the pre-update data, and then calling up the first method to execute update processing corresponding to the first method;

first abnormal end determination unit for determining whether the update processing has ended abnormally;

first rollback unit for, when the first abnormal end determination unit determines that the update processing has ended abnormally, calling up a method for returning the update processing target data to the pre-update data;

operation processing execution unit for, upon receiving a request to call up a second method which does not involve update of data, calling up the second method to execute operation processing corresponding to the second method;

second abnormal end determination unit for determining whether the operation processing has ended abnormally; and

second rollback unit for, when the second abnormal end determination unit determines that the operation processing has ended abnormally, calling up a method for returning the state to the state before execution of the operation processing.

(Supplementary note 2) The operation management server according to Supplementary note 1, further including a first rollback requirement determination unit for, upon receiving the request to call up the first method, determining whether the update processing corresponding to the first method is processing that requires rollback, wherein

when the first rollback requirement determination unit determines that the update processing requires rollback, the update processing execution unit calls up a method for obtaining the pre-update data which is the target of the update processing and obtains the pre-update data, and

when the first rollback requirement determination unit determines that the update processing requires rollback and the first abnormal end determination unit determines that the update processing has ended abnormally, the first rollback unit calls up a method for returning the update processing target data to the pre-update data.

(Supplementary note 3) The operation management server according to Supplementary note 1 or Supplementary note 2, further including data determination unit for, when the first abnormal end determination unit determines that the update processing has ended abnormally, calling up a method for obtaining update data which is the target of the update processing, obtaining the update data, and determining whether the obtained update data is different from the pre-update data obtained by the update processing execution unit, wherein

when the data determination unit determines that the update data is different from the pre-update data, the first rollback unit calls up a method for returning the update processing target data to the pre-update data.

(Supplementary note 4) The operation management server according to one of Supplementary note 1 to Supplementary note 3, further including a second rollback requirement determination unit for, when the second abnormal end determination unit determines that the operation processing has ended abnormally, determining whether the operation processing requires rollback, wherein

when the second rollback requirement determination unit determines that the operation processing requires rollback, the second rollback unit calls up a method for returning the state to the state before execution of the operation processing.

(Supplementary note 5) A rollback execution method which is executed by a server for managing operation of an application using an object oriented programming language, including:

an update processing execution step of calling up, upon receiving a request to call up a first method which involves update of data, a method for obtaining pre-update data which is a target of the update, obtaining the pre-update data, and then calling up the first method to execute update processing corresponding to the first method;

a first abnormal end determination step of determining whether the update processing has ended abnormally;

a first rollback step of calling up, when it is determined that the update processing has ended abnormally, a method for returning the update processing target data to the pre-update data;

an operation processing execution step of calling up, upon receiving a request to call up a second method which does not involve update of data, the second method to execute operation processing corresponding to the second method;

a second abnormal end determination step of determining whether the operation processing has ended abnormally; and

a second rollback step of calling up, when it is determined that the operation processing has ended abnormally, a method for returning the state to the state before execution of the operation processing.

(Supplementary note 6) A rollback execution program for having a computer execute each step according to Supplementary note 5.
(Supplementary note 7) An operation management server for managing operation of an application using an object oriented programming language, including:

update processing execution means for, upon receiving a request to call up a first method which involves an update of data, calling up a method for obtaining pre-update data which is a target of the update, obtaining the pre-update data, and then calling up the first method to execute update processing corresponding to the first method;

first abnormal end determination means for determining whether the update processing has ended abnormally;

first rollback means for, when the first abnormal end determination means determines that the update processing has ended abnormally, calling up a method for returning the update processing target data to the pre-update data;

operation processing execution means for, upon receiving a request to call up a second method which does not involve update of data, calling up the second method to execute operation processing corresponding to the second method;

second abnormal end determination means for determining whether the operation processing has ended abnormally; and

second rollback means for, when the second abnormal end determination means determines that the operation processing has ended abnormally, calling up a method for returning the state to the state before execution of the operation processing.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An operation management server for managing operation of an application using an object oriented programming language, comprising:
update processing execution unit for, upon receiving a request to call up a first method which involves an update of data, calling up a method for obtaining pre-update data which is a target of the update, obtaining the pre-update data, and then calling up the first method to execute update processing corresponding to the first method;
first abnormal end determination unit for determining whether the update processing has ended abnormally;
first rollback unit for, when the first abnormal end determination unit determines that the update processing has ended abnormally, calling up a method for returning the update processing target data to the pre-update data;
operation processing execution unit for, upon receiving a request to call up a second method which does not involve update of data, calling up the second method to execute operation processing corresponding to the second method;
second abnormal end determination unit for determining whether the operation processing has ended abnormally; and
second rollback unit for, when the second abnormal end determination unit determines that the operation processing has ended abnormally, calling up a method for returning the state to the state before execution of the operation processing.

2. The operation management server according to claim 1, further comprising a first rollback requirement determination unit for, upon receiving the request to call up the first method, determining whether the update processing corresponding to the first method is processing that requires rollback, wherein
when the first rollback requirement determination unit determines that the update processing requires rollback, the update processing execution unit calls up a method for obtaining the pre-update data which is the target of the update processing and obtains the pre-update data, and
when the first rollback requirement determination unit determines that the update processing requires rollback and the first abnormal end determination unit determines that the update processing has ended abnormally, the first rollback unit calls up a method for returning the update processing target data to the pre-update data.

3. The operation management server according to claim 1, further comprising data determination unit for, when the first abnormal end determination unit determines that the update processing has ended abnormally, calling up a method for obtaining update data which is the target of the update processing, obtaining the update data, and determining whether the obtained update data is different from the pre-update data obtained by the update processing execution unit, wherein
when the data determination unit determines that the update data is different from the pre-update data, the first rollback unit calls up a method for returning the update processing target data to the pre-update data.

4. The operation management server according to claim 1, further comprising a second rollback requirement determination unit for, when the second abnormal end determination unit determines that the operation processing has ended abnormally, determining whether the operation processing requires rollback, wherein
when the second rollback requirement determination unit determines that the operation processing requires rollback, the second rollback unit calls up a method for returning the state to the state before execution of the operation processing.

5. A rollback execution method which is executed by a server for managing operation of an application using an object oriented programming language, comprising:
an update processing execution step of calling up, upon receiving a request to call up a first method which involves update of data, a method for obtaining pre-update data which is a target of the update, obtaining the pre-update data, and then calling up the first method to execute update processing corresponding to the first method;
a first abnormal end determination step of determining whether the update processing has ended abnormally;
a first rollback step of calling up, when it is determined that the update processing has ended abnormally, a method for returning the update processing target data to the pre-update data;
an operation processing execution step of calling up, upon receiving a request to call up a second method which does not involve update of data, the second method to execute operation processing corresponding to the second method;
a second abnormal end determination step of determining whether the operation processing has ended abnormally; and
a second rollback step of calling up, when it is determined that the operation processing has ended abnormally, a method for returning the state to the state before execution of the operation processing.

6. A rollback execution program for having a computer execute each step according to claim 5.

7. An operation management server for managing operation of an application using an object oriented programming language, comprising:
update processing execution means for, upon receiving a request to call up a first method which involves an update of data, calling up a method for obtaining pre-update data which is a target of the update, obtaining the pre-update data, and then calling up the first method to execute update processing corresponding to the first method;
first abnormal end determination means for determining whether the update processing has ended abnormally;
first rollback means for, when the first abnormal end determination means determines that the update processing has ended abnormally, calling up a method for returning the update processing target data to the pre-update data;
operation processing execution means for, upon receiving a request to call up a second method which does not involve update of data, calling up the second method to execute operation processing corresponding to the second method;
second abnormal end determination means for determining whether the operation processing has ended abnormally; and
second rollback means for, when the second abnormal end determination means determines that the operation processing has ended abnormally, calling up a method for returning the state to the state before execution of the operation processing.
